(19) United States
(12) Patent Application Publication
(10) Pub. No.: US 2023/0126849 A1
(43) Pub. Date: Apr. 27, 2023

(54) LEARNING METHOD FOR THE DETECTION OF ANOMALIES FROM MULTIVARIATE DATA SETS AND ASSOCIATED ANOMALY DETECTION METHOD

(71) Applicant: CARTESIAM, Toulon (FR)

(72) Inventors: François de Grimaudet de Rochebouët, Toulon (FR); Mohamed Ali Moussa, Toulon (FR)

(21) Appl. No.: 18/145,984

(22) Filed: Dec. 23, 2022

Related U.S. Application Data
(63) Continuation-in-part of application No. PCT/EP2021/066867, filed on Jun. 21, 2021.

(30) Foreign Application Priority Data
Jun. 25, 2020 (FR) 2006674

(51) Int. Cl. G06F 17/15; G06F 17/17; G06F 18/2413

(52) U.S. Cl. CPC G06F 17/153; G06F 17/17; G06F 18/2413

(57) ABSTRACT

A method can be implemented on a microcontroller that includes at least one memory. The microcontroller is configured to receive sets of multivariable data from at least one sensor and the memory is configured to store a predefined number of categories. A category is associated with a mean and a covariance matrix. The method can be used to the detection of anomalies from the sets of multivariable data.

### CROSS-REFERENCE TO RELATED APPLICATIONS

This application is a continuation-in-part of International Application No. PCT/EP2021/066867, filed on Jun. 21, 2021, which claims the benefit of French Application No. FR2006674, filed Jun. 25, 2020, which applications are hereby incorporated herein by reference.

### TECHNICAL FIELD

The present invention relates generally to a learning method for the detection of anomalies from multivariate data sets and associated anomaly detection method.

### BACKGROUND

In order to detect anomalies in a system monitored from several variables via at least one sensor, for example by the temperature, the pressure and the humidity, it is known to use techniques, for example based on networks of neurons, allowing obtaining high detection rates. Such techniques often require the use of powerful processors and a significant amount of memory resources to be functional.

Thus, these techniques are incompatible with an implementation on microcontroller constrained in terms of memory resources, but having a high degree of integration thanks to the reduced dimensions thereof.

There is therefore a need to design an algorithm for detecting anomalies from multivariable data, allowing obtaining performance which are comparable to those obtained with the other known techniques for detecting anomalies, implemented on a microcontroller which can be embedded on any device regardless of its environment.

### SUMMARY

Embodiments of the invention relate to processes for detecting anomalies and, in particular cases, to processes for detecting anomalies from sets of multivariable data, implemented on a microcontroller.

Embodiments relate to an incremental learning process for detecting anomalies from sets of multivariable data, implemented on a microcontroller. Embodiments also relate to a microcontroller implementing the learning process and/or the detection process, a device embedding the microcontroller and a computer program product.

In one embodiment, an incremental learning process for detecting anomalies can be implemented on a microcontroller including at least one memory. The microcontroller is configured to receive sets of multivariable data from at least one sensor. The memory is configured to store a predefined number of categories, a category being associated with a mean and a covariance matrix. The process includes a number of steps.

An initialization step includes at least one sub-step of creating a category and storing the category in the memory, so that the number of created categories is strictly less than the predefined number of categories. For at least one group of sets of learning data, a mean and a covariance matrix are calculated for the group of sets of learning data. If a condition according to which the covariance matrix of the group of sets of learning data is poorly conditioned is verified, the condition depending on a LU factorization of the covariance matrix, then a set of data is added to the group of sets of learning data and the mean and the covariance matrix of the group of sets of learning data are updated. A category associated with the mean and the covariance matrix of the group of sets of learning data is created and stored the category in the memory. For each category stored in the memory, a first measurement of distance between the category and each other category stored in the memory from the associated means and covariance matrices is calculated. Selecting the two categories corresponding to the first minimum distance measurement are selected and a single category is created by merging the two selected categories.

Embodiments of the invention offer solutions to the previously mentioned problems, by allowing detecting anomalies from multivariable data thanks to an algorithm implemented on a microcontroller having a high integration capacity.

### BRIEF DESCRIPTION OF THE DRAWINGS

The figures are shown for illustrative and non-limiting purposes of the invention.

FIG. 1 is a block diagram illustrating the sequence of steps of a learning process according to embodiments of the invention.

FIG. 2 is a block diagram illustrating a first embodiment of an initialization step of the learning process according to embodiments of the invention.

FIG. 3 is a block diagram illustrating the sequence of steps of an anomaly detection process according to embodiments of the invention.

FIG. 4 is a schematic representation of a device embedding a microcontroller according to embodiments of the invention.

### DETAILED DESCRIPTION OF ILLUSTRATIVE EMBODIMENTS

The embodiments will first be disclosed in general terms followed by a look with respect to the drawings.

A first aspect of the invention relates to an incremental learning process for detecting anomalies implemented on a microcontroller including at least one memory. The microcontroller is configured to receive sets of multivariable data from at least one sensor and the memory is configured to store a predefined number of categories, a category being associated with a mean and a covariance matrix. The process includes the following steps. Initialization includes at least one sub-step of creating a category and storing the category in the memory, so that the number of created categories is strictly less than the predefined number of categories. For at least one group of sets of learning data the following steps are performed:

calculating a mean and a covariance matrix for the group of sets of learning data;

if a condition according to which the covariance matrix of the group of sets of learning data is poorly conditioned is verified, the condition depending on a LU factorization of the covariance matrix adding a set of data to the group of sets of learning data and updating the mean and the covariance matrix of the group of sets of learning data;

creating a category associated with the mean and the covariance matrix of the group of sets of learning data and storing the category in the memory;

for each category stored in the memory, calculating a first measurement of distance between the category and each other category stored in the memory from the associated means and covariance matrices; and

selecting the two categories corresponding to the first minimum distance measurement and creating a single category by merging the two selected categories.

Thanks to embodiments disclosed herein, a category is created for a group of sets of learning data so as to avoid the creation of categories that do not provide new information relative to the existing categories. The test of obtaining a well-conditioned covariance matrix is carried out without calculating the decomposition into singular values, a process conventionally used to test the good conditioning of a matrix, because this would require a significant amount of calculations incompatible with the reduced calculation capacities of a microcontroller. The test of the good conditioning of the covariance matrix is carried out using an adaptation of the LU factorization of this matrix which requires much less calculation.

In order not to exceed the predefined number of categories allocated in the memory of the microcontroller, as soon as a new category is created in the memory, each category is compared with the other categories using a distance measurement. The two closest categories, that is to say having the lowest distance measurement, are then merged into a single category to free up space in the memory and to be able to create new categories more representative of the others sets of data.

In addition to the features which have just been mentioned in the previous paragraph, the process according to the first aspect of the invention may have one or more additional characteristics among the following, considered individually or according to all technically possible combinations.

According to a variant, the initialization step includes the following sub-steps:

if a condition according to which the number of categories stored in the memory is strictly less than the predefined number of categories is verified:

for a group of sets of initialization data calculating a mean and a covariance matrix for the group of sets of initialization data;

if the condition according to which the covariance matrix of the group of sets of initialization data is poorly conditioned is verified adding a set of data to the group of sets of initialization data and updating the mean and the covariance matrix of the group of sets of initialization data;

creating a category associated with the mean and the covariance matrix of the group of sets of initialization data and storing the category in the memory.

Thus, categories are created if the predefined number of categories minus one is not reached, which allows comparing a new category created during learning with a maximum of other categories.

According to a variant compatible with the preceding variants, the first distance measurement is the Bhattacharyya distance. A second aspect of the invention relates to an anomaly detection process implemented on a microcontroller including at least one memory. The microcontroller is configured to receive sets of multivariable data from at least one sensor and the memory is configured to store a predefined number of categories, a category being associated with a mean and a covariance matrix. The process includes the steps of the learning process according to the first aspect of the invention followed by the following steps:

for each received set of data storing the set of data in the memory;

for each category stored in the memory, calculating a second measurement of distance between the set of data and the category and selecting the second minimum distance measurement;

if a condition according to which the second minimum distance measurement is greater than a distance threshold is verified, detecting an anomaly; and

deleting the set of data from the memory.

Thus, the anomaly detection process according to the second aspect of the invention uses the categories created during the learning process according to the first aspect of the invention to effectively detect the anomalies by measuring the distance between the set of data and each category stored in the memory. The set of data is considered as abnormal if it is too far from the categories stored in the memory.

According to a variant, the second distance measurement is the Mahalanobis distance.

According to a variant compatible with the previous variant, the distance threshold is obtained from the X2 (“chi-square”) distribution.

According to a variant compatible with the previous variants, the distance threshold is weighted by a sensitivity factor.

Thus, it is possible to adjust the sensitivity of the process to abnormal sets of data.

A third aspect of the invention relates to a computer configured to implement the steps of the learning process according to the first aspect of the invention and/or the steps of the anomaly detection process according to the second aspect of the invention, including a processor and a memory and receiving sets of multivariable data from at least one sensor.

According to a variant, the computer according to the invention is a microcontroller.

A fourth aspect of the invention relates to a device embedding a microcontroller according to a third aspect of the invention.

A fifth aspect of the invention relates to a computer program product comprising instructions which, when the program is executed by a computer, lead the latter to implement the steps of the learning process according to the first aspect of the invention and/or the steps of the anomaly detection process according to the second aspect of the invention.

The invention and the different applications thereof will be better understood on reading the following description and on examining the accompanying figures.

Unless otherwise specified, the same element appearing in different figures has a single reference.

A first aspect of the invention relates to an incremental learning process for detecting anomalies. The term “incremental learning” means a learning carried out from data received over time.

A second aspect of the invention relates to a process for detecting anomalies, comprising the learning process according to the first aspect of the invention.

The learning process according to the first aspect of the invention and the anomaly detection process according to the second aspect of the invention are each made from sets of multivariable data.

A set of multivariable data is a set of data including several variables, that is to say several types of data or a single type of data having a multiple dimension. A variable is for example a pressure measurement, a temperature measurement, a vibration measurement or even a humidity measurement. A set of multivariable data can then include, for example, a pressure measurement, a temperature measurement, and a humidity measurement. The set of multivariable data then includes three variables.

The term “anomaly detection” means the identification of particular sets of data which differ significantly from the sets of data processed in the learning phase. The anomaly detection is for example used for the supervision of industrial machines in the context of the predictive maintenance, for the detection of energy overconsumption in a household or even to detect an intruder in a room.

The learning process according to the first aspect of the invention and the anomaly detection process according to the second aspect of the invention are each implemented on a microcontroller receiving the sets of multivariable data from at least one sensor.

A third aspect of the invention relates to a microcontroller configured to implement the learning process according to the first aspect of the invention and/or the detection process according to the second aspect of the invention.

Thus, the same microcontroller can be used to implement the learning process according to the first aspect of the invention and the detection process according to the second aspect of the invention.

FIG. 4 shows a schematic representation of a microcontroller 200 according to the third aspect of the invention. The microcontroller 200 is an integrated circuit including at least one microprocessor 202 and at least one memory 201.

In FIG. 4, the microcontroller 200 includes a single memory 201 and a single microprocessor 202. The microprocessor 202 has for example a frequency which is greater than 2 MHz. The microprocessor μp 202 is for example a 50 MHz microprocessor. The memory 201 has, for example, a random access memory of at least 2 kilobytes. The memory 201 for example has a random access memory of 4 kilobytes.

It is assumed that a category follows a Gaussian distribution that can be associated with a mean and a covariance matrix.

The microcontroller 200 receives the sets of multivariable data allowing the implementation of the learning process according to the first aspect of the invention and/or of the detection process according to the second aspect of the invention, of at least one sensor 203.

As the sets of data are multivariable, if the microcontroller 200 receives the sets of multivariable data from a single sensor 203, the sensor 203 is then capable of acquiring data of different types. Using the previous example of the set of multivariable data including three variables, the single sensor 203 is then capable of carrying out pressure measurements, temperature measurements, and humidity measurements.

The microcontroller can also receive sets of multivariable data from a plurality of sensors 203. Each sensor 203 can be capable of acquiring data of a single type or of different types.

In FIG. 4, the microcontroller receives the sets of multivariable data from three sensors 203. Using the previous example of the set of multivariable data including three variables, a first sensor 203 is for example capable of carrying out pressure measurements, a second sensor 203 temperature measurements, and a third sensor 203 humidity measurements.

A sensor 203 is for example an accelerometer having a given sampling frequency and a number of axes which is for example equal to 3. A measurement then includes 3 values, each corresponding to an axis.

A sensor 203 is for example a thermometer delivering temperature measurements.

A sensor 203 is for example a barometer delivering pressure measurements.

A sensor 203 is for example a thermal camera. A measurement is for example an 8×8 matrix of pixels.

According to a first embodiment, each sensor 203 is connected to the microcontroller 200 via a serial data bus, for example an I₂C, SPI, CAN or UART serial data bus.

According to a second embodiment, the microcontroller 200 receives for example the sets of multivariable data of each sensor 203 via a wired connection, for example an Ethernet link, or a wireless connection, for example a Bluetooth or WIFI connection.

In FIG. 4, the microcontroller 200 is embedded on a device 300. In FIG. 4, the sensors 203 are also embedded in the device 300. In this case, the device 300 can be the device for which it is desired to carry out the anomaly detection.

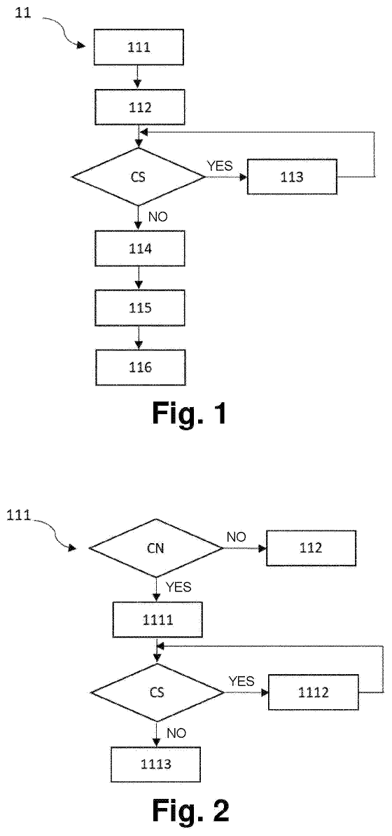

FIG. 1 is a block diagram illustrating the sequence of steps of the learning process 11 according to the first aspect of the invention. The learning process 11 is an unsupervised incremental learning process carried out on the sets of multivariable data provided by the sensor(s) 203. The term “unsupervised learning” means machine learning carried out with unlabeled data, that is to say raw data as provided by the sensor(s) 203.

The learning process 11 includes a first initialization step 111 during which at least one category is created then stored in the memory 201 of the microcontroller. During the first step in, the number of created categories is strictly less than a predefined number of categories, that is to say less than or equal to the predefined number of categories minus one.

The predefined number of categories is selected so that the storage capacities of the memory 201 allow it to store at least one number of categories equal to the predefined number of categories. For example, if the memory 201 has a random access memory of 4 kilobytes allowing it, for example, to store a maximum of 10 categories, the predefined number of categories is less than or equal to 10.

FIG. 2 is a block diagram illustrating a first exemplary embodiment of the first step in of initialization of the learning process ii. The first step 111 illustrated in FIG. 2 is carried out if a condition CN is verified. The condition CN is verified if the number of categories stored in the memory 201 of the microcontroller 200 is strictly less than the predefined number of categories.

For example, if the predefined number of categories is 22, the first step 111 is carried if 21 categories are not stored in the memory 201. If the CN condition is not or no longer verified, the first step 111 is completed and a second step 112 of the learning process 11 is proceeded with.

The sub-steps of the first step 111 are carried out for at least one group of sets of multivariable data, hereinafter called group of sets of initialization data. A first sub-step 1111 of the first step 111 consists in calculating a mean and a covariance matrix for the group of sets of initialization data.

For example, a set of data i includes p variables. Such a set of data i can be modelled by a vector (X_i) \vec{} such that:

$${\vec{X}}_{l} = ( \begin{matrix}\begin{matrix}{X}_{i}^{1} \\ ⋮\end{matrix} \\ {X}_{i}^{p}\end{matrix} )$$

A group of sets of data includes n sets of data and therefore n×p variables. The group of sets of data can then be modelled by a vector \vec{E} such that:

$$\vec{E} = ( \begin{matrix}\vec{{X}_{1}} \\ ⋮ \\ \vec{{X}_{n}}\end{matrix} ) = ( \begin{matrix}\begin{matrix}\begin{matrix}{X}_{1}^{1} \\ ⋮\end{matrix} \\ {X}_{1}^{p}\end{matrix} \\ ⋮ \\ {X}_{2}^{p} \\ ⋮ \\ ⋮ \\ {X}_{n}^{1} \\ ⋮ \\ {X}_{n}^{p}\end{matrix} )$$

The mean m of the group of sets of initialization data is then calculated as:

$${m}_{n} ( \vec{E} ) = \frac{1}{n} {\sum }_{j = 1}^{j = n} \vec{{X}_{j}}$$

In order not to need to memorize all sets of data, the mean can be calculated incrementally, that is to say:

$${m}_{n} ( \vec{E} ) = \frac{1}{n} ( \vec{{X}_{n}} + {\sum }_{j = 1}^{j = n - 1} \vec{{X}_{j}} ) = \frac{1}{n} ( \vec{{X}_{n}} + ( n - 1 ) {m}_{n - 1} ( \vec{E} ) )$$

The covariance matrix Cov of the group of sets of initialization data is then calculated as:

$${Cov}_{n} ( E ) = ( \begin{matrix}Cov ( \vec{{X}_{1}} , \vec{{X}_{1}} ) & … & Cov ( \vec{{X}_{1}} , \vec{{X}_{n}} ) \\ ⋮ & … & ⋮ \\ Cov ( \vec{{X}_{n}} , \vec{{X}_{1}} ) & … & Cov ( \vec{{X}_{n}} , \vec{{X}_{n}} )\end{matrix} )$$

With Cov(Y, Z), the covariance between a variable Y and a variable Z is expressed as:

$${Cov}_{n} ( Y , Z ) = {\sum }_{j = 1}^{j = n} ( {Y}_{i} - {m}_{n} ( Y ) ) ( {Z}_{i} - {m}_{n} ( Z ) )$$

In order not to need to memorize all sets of data, the covariance matrix can be calculated incrementally:

$${Cov}_{n} ( Y , Z ) = \frac{( n - 1 ) {Cov}_{n - 1} ( Y , Z ) + ( {Y}_{n} - {m}_{n} ( {Y}_{i} ) ) ( {Z}_{n} - {m}_{n - 1} ( Z ) )}{n}$$

The covariance matrix Cov as defined is a square matrix.

Considering a simple example in which each set of data includes two variables and that the group of sets of data includes three sets of data, there is obtained:

$$\vec{E} = ( \begin{matrix}\vec{{X}_{1}} \\ \vec{{X}_{2}} \\ \vec{{X}_{3}}\end{matrix} ) = ( \begin{matrix}\begin{matrix}\begin{matrix}{X}_{1}^{1} \\ {X}_{1}^{2}\end{matrix} \\ {X}_{2}^{1}\end{matrix} \\ {X}_{2}^{2} \\ {X}_{3}^{1} \\ {X}_{3}^{2}\end{matrix} )$$

$${m}_{n} ( E ) = ( \begin{matrix}\begin{matrix}\frac{{X}_{1}^{1} + {X}_{1}^{2}}{2} \\ \frac{{X}_{2}^{1} + {X}_{2}^{2}}{2}\end{matrix} \\ \frac{{X}_{3}^{1} + {X}_{3}^{2}}{2}\end{matrix} )$$

$${Cov}_{n} ( \vec{E} ) = ( \begin{matrix}Cov ( {\vec{X}}_{1} , {\vec{X}}_{1} ) & Cov ( {\vec{X}}_{1} , {\vec{X}}_{2} ) & Cov ( {\vec{X}}_{1} , {\vec{X}}_{3} ) \\ Cov ( {\vec{X}}_{2} , {\vec{X}}_{1} ) & Cov ( {\vec{X}}_{2} , {\vec{X}}_{2} ) & Cov ( {\vec{X}}_{2} , {\vec{X}}_{3} ) \\ Cov ( {\vec{X}}_{3} , {\vec{X}}_{1} ) & Cov ( {\vec{X}}_{3} , {\vec{X}}_{2} ) & Cov ( {\vec{X}}_{3} , {\vec{X}}_{3} )\end{matrix} )$$

A second sub-step 1112 of the first step 111 is carried out if a condition CS is satisfied for the covariance matrix of the group of sets of initialization data. The condition CS for a given group is verified if the covariance matrix of the given group is poorly conditioned.

For example, it is considered that the condition CS is not verified if the LU factorization of the covariance matrix satisfies certain conditions on the diagonal elements, for example if the ratio between the minimum diagonal element and the maximum diagonal element is greater than a threshold.

Cov=LUThe LU decomposition of the covariance matrix Cov can be written:

Cov=LU

Cov=LUwith L a lower triangular matrix and U an upper triangular matrix.

The threshold is for example between 0.0001 and 0.1.

A square matrix is poorly conditioned if its inverse matrix is sensitive to slight modifications of the elements thereof.

Thus, if the condition CS is not verified for the initial group of sets of initialization data, that is to say if the covariance matrix calculated for the initial group of sets of initialization data is well conditioned, the second sub-step 1112 is not carried out and a third sub-step 1113 of the first step 111 is proceeded with.

The second sub-step 1112 consists of adding a set of data to the group of sets of initialization data then updating the mean and the covariance matrix of the group of sets of initialization data, that is to say recalculating the mean and the covariance matrix for the group of sets of initialization data to which the set of data has been added.

If, following the second sub-step 1112, the condition CS is still verified, the second sub-step 1112 is carried out again and so on until the condition CS is no longer verified.

As soon as the condition CS is no longer verified for the group of sets of initialization data to which at least one new set of data has been added, IO to the third sub-step 1113 is proceeded with.

The third sub-step 1113 consists in creating a category associated with the mean and the covariance matrix of the group of sets of initialization data then in storing the category created in the memory 201 of the microcontroller 200.

The covariance matrix associated with the category is the covariance matrix for which the condition CS has not been verified, that is to say a well-conditioned covariance matrix. The covariance matrix associated with the category may be the covariance matrix calculated for the initial group of sets of initialization data or for the initial group of sets of initialization data to which one or more set(s) of data has/have been added during of the second sub-step 1112.

The sub-steps of the first step 111 are carried out if the condition CN is verified, that is to say if there is a number of categories stored in the memory 201 which is strictly lower than the predefined number of categories.

According to a second exemplary embodiment, the first initialization step 111 may consist in creating a number of categories which is strictly lower than the predefined number of categories, by associating random or predetermined mean and covariance matrix to each category.

The following steps of the learning process 11 are carried out for at least one group of sets of multivariable data, hereinafter called group of sets of learning data.

A second step 112 of the learning process 11 consists in calculating a mean and a covariance matrix for the group of sets of learning data.

A third step 113 of the learning process 11 is carried out if the condition CS is verified for the group of sets of learning data, that is to say if the covariance matrix associated with the group of sets of learning data is poorly conditioned.

If the condition CS is not verified for the initial group of sets of learning data, that is to say if the covariance matrix associated with the group of sets of learning data is well conditioned, the third step 113 is not carried out and a fourth step 114 of the learning process 11 is proceeded with.

The third step 113 consists in adding a set of data to the group of sets of learning data then in updating the mean and the covariance matrix of the group of sets of learning data, that is to say in recalculating the mean and the covariance matrix for the group of sets of learning data to which the set of data has been added.

If, following the third step 113, the condition CS is still verified, the third step 113 is carried out again and so on until the condition CS is no longer verified.

As soon as the condition CS is no longer verified for the group of sets of learning data to which at least one new set of data has been added, the fourth step 114 is proceeded with.

The fourth step 114 consists in creating a category associated with the mean and the covariance matrix of the group of sets of learning data, then in storing the category created in the memory 201.

The covariance matrix associated with the category is the covariance matrix for which the condition CS has not been verified, that is to say a well-conditioned covariance matrix. The covariance matrix associated with the category can be the covariance matrix calculated for the initial group of sets of learning data or for the initial group of sets of learning data to which one or more set(s) of data has/have been added during the third step 113.

A fifth step 115 then comprises calculating, for each category stored in the memory 201, a first measure of distance between the category and each other category stored in the memory 201.

For example, if a first category, a second category and a third category are stored in the memory 201, the fifth step 115 consists in calculating a first measurement of distance between the first category and the second category, a first measurement of distance between the first category and the third category and a first measurement of distance between the second category and the third category.

The first measurement of distance between a first category associated with is a mean m₁ and a covariance matrix M₁ and a second category associated with a mean m₂ and a covariance matrix M₂ is for example the Bhattacharyya distance D_{B} being defined as:

$${D}_{B} = \frac{1}{8} {( {m}_{1} - {m}_{2} )}^{T} {M}^{- 1} ( {m}_{1} - {m}_{2} ) + \frac{1}{2} ln ( \frac{det M}{\sqrt{det {M}_{1} , det {M}_{2}}} )$$

With: A^{T} the transpose of the matrix A, A⁻¹ the inverse of the matrix A, det A the determinant of the matrix A, In the natural logarithm operator and M the matrix being defined as:

$$\text{?} 2$$

$$\text{?} \text{indicates text missing or illegible when filed}$$

A sixth step 116 then consists in selecting the two categories for which the first minimum distance measurement was calculated in the fifth step 115, that is to say the first distance measurement having the lowest value among all first distance measurements calculated in the fifth step 115, then in merging the two selected categories to create a single category.

In order to merge a first category associated with n₁ sets of data, a mean mi and a covariance matrix M1 and a second category associated with n2 sets of data, a mean m2 and a covariance matrix M2, a category is created, for example, associated with n sets of data, a mean m and a covariance matrix M such that:

$$n = {n}_{1} + {n}_{2}$$

$$m = \frac{1}{n} ( {n}_{1} {m}_{1} + {n}_{2} {m}_{2} )$$

$$M = \frac{1}{n - 1} ( ( {n}_{1} - 1 ) {M}_{1} + ( {n}_{2} - 1 ) {M}_{2} + \frac{{n}_{1} {n}_{2}}{n} ( {m}_{1} - {m}_{2} ) {( {m}_{1} - {m}_{2} )}^{T} )$$

The two categories merged in the sixth step 116 can be the category created in the fourth step 114 and another category stored in the memory 201 or two categories stored in the memory 201 different from the category created in the fourth step 114.

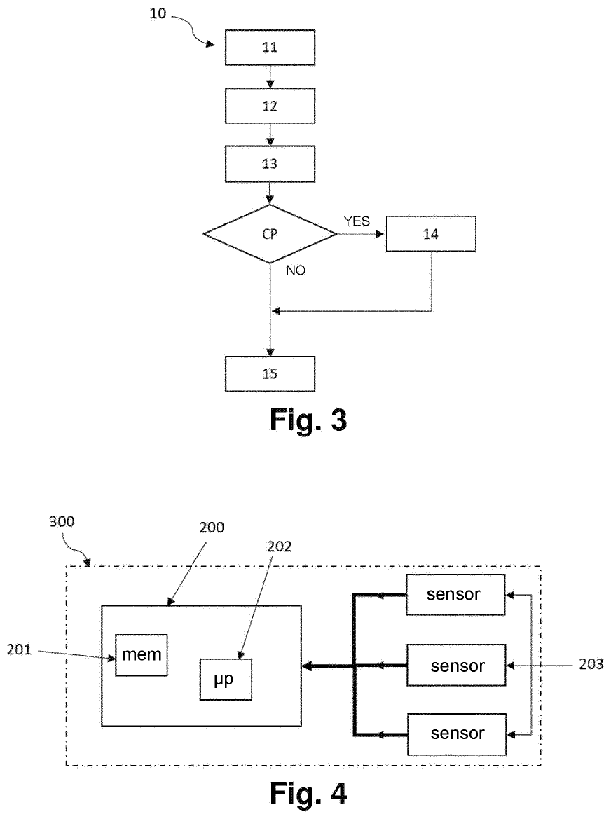

FIG. 3 is a block diagram illustrating the sequence of steps of the anomaly detection process 10 according to the second aspect of the invention.

Once the learning process ii has been carried out, the steps of the anomaly detection process 10 according to the second aspect of the invention are carried out for each set of data received by the sensor(s) 203.

In FIG. 3, the learning process 11 is considered as a first step 11 of the anomaly detection process 10. A second step 12 of the anomaly detection process 10 consists in storing the set of data received in the memory 201 of the microcontroller 200. A third step 13 of the anomaly detection process 10 consists in calculating, for each category stored in the memory 201, a second measurement of distance between the set of data and the category.

For example, if a first category, a second category and a third category are stored in the memory 201, the third step 13 consists in calculating a second measurement of distance between the set of data and the first category, a second measurement of distance between the set of data and the second category and a second measurement of distance between the set of data and the third category.

The second measurement of distance between a set of data modelled by a vector X and a category associated with a mean m and with a covariance matrix M is for example the Mahalanobis distance DM, being defined as:

D_{M}=\sqrt{(X−m)^{T}M⁻¹(X−m)}

The third step 13 then consists in selecting the second minimum distance measurement, that is to say the second distance measurement having the lowest value among all second distance measurements calculated in the third step 13.

A fourth step 14 of the anomaly detection process 10 is carried out if a condition CP is verified. The condition CP is verified if the second minimum distance measurement is greater than a distance threshold.

If the condition CP is not verified, that is to say if the second minimum distance measurement is less than the distance threshold, the fourth step 14 is not carried out and a fifth step 15 is directly proceeded with.

The distance threshold is for example obtained from the X² (“chi-square”) distribution by choosing, as degree of freedom, the number of variables in the data set.

The distance threshold is for example weighted by a sensitivity factor. The sensitivity factor is for example comprised between 0.5 and 1.5. By default, the sensitivity factor is set to 1.

The fourth step 14 consists in detecting an anomaly.

The fourth step 14 can for example consist in triggering an alarm or in sending an alert message to a given piece of equipment.

The fifth step 15 of the anomaly detection process 10 consists in deleting the set of data received from the memory 201 of the microcontroller 200.

Embodiments can be incorporated to detect anomalies in industrial machines, energy over-consumption in power stations, or detect a change in camera sensor output, as just a few examples. These techniques can further be implemented in supervising the functionality of computers, microprocessors, smartphones, PDAs, IoT devices, digital signal processors (DSP), a programmable System-on-a-chip (SoC), and other micro-processing applications. The associated sensor includes an accelerometer, thermometer delivering temperature data sets, thermal camera to study the environment for surveillance. As such, the disclosed techniques can be used in a number of industries including automotive, consumer electronics, medical instruments, social, avionics, and the industrial sector for machine learning or other high-complexity computational applications.

For example, the techniques disclosed herein can be used in a method of performing multivariate anomaly detection. A learning process based on the embodiments of the invention is executed using one or more sensors to collect sets of multivariable data and incrementally building a model that describes an observed phenomena. This process of collecting and building the model during a learning period. After the learning period, the model is used to monitor a physical system for anomolous behavior. In response to a finding of anomolous behavior, action can be taken to address the anomolous behavior. For example, an alert can be issued and the physical system can be modified to address the anomolous behavior.

In one specific example, the multivariate anomaly detection solution as disclosed herein can be used to monitor an automated climatization mechanism. The aim of this system is to guarantee a stable temperature within a certain margin, as a function of various parameters such as temperature, pressure, humidity, and occupancy. These parameters can be detected using temperature, pressure, humidity, and time of flight sensors, respectively. The multivariate anomaly detection solution is used to ensure that the climatization system is properly functioning. To do that, the functioning regimes are learned. For example, a microcontroller embedding the anomaly detection solution collects data from the sensors and starts to incrementally build a model that describes the observed phenomena. The duration of the learning process is user dependent and can be determined by one of skill in the art depending on the particular application. The duration will be specified before starting the process of learning.

After repeating the process of collecting and building the model during the learning process, the microcontroller can separate normal functioning from abnormal behaviors. During this monitoring phase, any anomalous behavior can be detected and addressed. For example, a technician can be alerted to find a specific issue, e.g., a malfunctioning fan or another part that is not operating properly. Alternatively, the issue can be deduced using the sensor information. In either case, the system can be fixed by addressing the issue, e.g., by repairing or replacing the malfunctioning part.

Another example of multivariate anomaly detection use is in hydraulic pump monitoring systems. These systems can be equipped with vibration, current and flow measurement sensors. The microcontroller embedding the anomaly detection solution incrementally collects data from these sensors and builds the model that describes the normal functioning. The process of collecting and learning is performed during a predefined period. After this period, the system can raise an alert in case of anomalous behavior. In response to the alert, the monitoring system repaired to address the anomalous behavior.

What is claimed is:

1. A method implemented on a microcontroller that includes at least one memory, the microcontroller being configured to receive sets of multivariable data from at least one sensor, the memory being configured to store a predefined number of categories, a category being associated with a mean and a covariance matrix, the method comprising:
performing an initialization that includes creating one or more categories and storing each category in the memory, wherein the number of created categories is strictly less than the predefined number of categories;
for at least one group of sets of learning data:
calculating a mean and a covariance matrix for the group of sets of learning data;
determining whether a first condition is verified, the first condition depending on an LU factorization of the covariance matrix and the first condition being verified according to whether the covariance matrix of the group of sets of learning data is poorly conditioned;
when the first condition is verified, adding a set of data to the group of sets of learning data and updating the mean and the covariance matrix of the group of sets of learning data;
creating a category associated with the mean and the covariance matrix of the group of sets of learning data and storing the category in the memory;
for each category stored in the memory, calculating a first measurement of distance between the category and each other category stored in the memory from the associated means and covariance matrices;
selecting two categories corresponding to a first minimum distance measurement; and
creating a single category by merging the two selected categories.

2. The method according to claim 1, wherein the initialization comprises:
determining that a second condition is verified, the second condition being verified according to whether the number of categories stored in the memory is strictly less than the predefined number of categories;
for a group of sets of initialization data:
calculating a mean and a covariance matrix for the group of sets of initialization data;
when the first condition is verified, adding a set of data to the group of sets of initialization data and updating the mean and the covariance matrix of the group of sets of initialization data; and
creating a category associated with the mean and the covariance matrix of the group of sets of initialization data and storing the category in the memory.

3. The method according to claim 1, wherein the first distance measurement is the Bhattacharyya distance.

4. The method according to claim 1, further comprising for each received set of data:
storing the set of data in the memory;
for each category stored in the memory, calculating a second measurement of distance between the set of data and the category and selecting a second minimum distance measurement;
determining that a third condition is verified according to whether the second minimum distance measurement is greater than a distance threshold;
in response to the third condition being verified, detecting an anomaly; and
deleting the set of data from the memory.

5. The method according to claim 4, wherein the second distance measurement is a Mahalanobis distance.

6. The method according to claim 4, wherein the distance threshold is obtained from a X² (“chi-square”) distribution.

7. The method according to claim 4, wherein the distance threshold is weighted by a sensitivity factor.

8. A method of performing multivariate anomaly detection, the method comprising:
performing a learning process using the method of claim 1 to generate a multivariate anomaly detection solution, the learning process including using the at least one sensor to collect the sets of multivariable data, incrementally building a model that describes an observed phenomena, and repeating the steps of collecting and building the model during a learning period;
after the learning period, using the multivariate anomaly detection solution to monitor a physical system for anomolous behavior; and
in response to a finding of anomolous behavior, taking action to address the anomolous behavior.

9. The method of claim 8, wherein taking action to address the anomolous behavior comprises repairing or replacing a malfunctioning part of the physical system.

10. The method of claim 8, wherein the physical system implements an automated climatization mechanism; and
the at least one sensor comprises a temperature sensor, a pressure sensor, a humidity sensor, and a time of flight sensor.

11. The method of claim 8, wherein the physical system comprising a hydraulic pump monitoring system; and
the at least one sensor comprises a vibration sensor, a current sensor, and a flow measurement sensor.

12. An apparatus comprising:
a microcontroller;
data memory coupled to the microcontroller, the data memory capable of storing a predefined number of categories, a category being associated with a mean and a covariance matrix;
program memory storing program instructions that, when executed by the microcontroller, cause the microcontroller to:
receive sets of multivariable data from at least one sensor;
perform an initialization that includes creating one or more categories and storing each category in the data memory, wherein the number of created categories is strictly less than the predefined number of categories;
for at least one group of sets of learning data:
calculate a mean and a covariance matrix for the group of sets of learning data;
determine that a first condition is verified, the first condition depending on an LU factorization of the covariance matrix and the first condition being verified according to whether the covariance matrix of the group of sets of learning data is poorly conditioned;
in response to the first condition being verified, add a set of data to the group of sets of learning data and update the mean and the covariance matrix of the group of sets of learning data;
create a category associated with the mean and the covariance matrix of the group of sets of learning data and storing the category in the data memory;
for each category stored in the data memory, calculate a first measurement of distance between the category and each other category stored in the data memory from the associated means and covariance matrices;
select two categories corresponding to a first minimum distance measurement; and
create a single category by merging the two selected categories.

13. The apparatus according to claim 12, wherein the the program instructions further cause the microcontroller to:
determine that a second condition is verified, the second condition being verified according to whether the number of categories stored in the data memory is strictly less than the predefined number of categories;
for a group of sets of initialization data:
calculate a mean and a covariance matrix for the group of sets of initialization data;
in response to the first condition being verified, add a set of data to the group of sets of initialization data and update the mean and the covariance matrix of the group of sets of initialization data; and
create a category associated with the mean and the covariance matrix of the group of sets of initialization data and storing the category in the data memory.

14. The apparatus according to claim 12, wherein the first distance measurement is the Bhattacharyya distance.

15. The apparatus according to claim 12, wherein for each received set of data the program instructions further cause the microcontroller to:
store the set of data in the data memory;
for each category stored in the data memory, calculate a second measurement of distance between the set of data and the category and select a second minimum distance measurement;
determine that a third condition is verified according to whether the second minimum distance measurement is greater than a distance threshold;
in response to the third condition being verified, detect an anomaly; and
delete the set of data from the data memory.

16. The apparatus according to claim 15, wherein the second distance measurement is a Mahalanobis distance.

17. The apparatus according to claim 15, wherein the distance threshold is obtained from a X² (“chi-square”) distribution.

18. The apparatus according to claim 15, wherein the distance threshold is weighted by a sensitivity factor.

19. The apparatus according to claim 12, further comprising the at least one sensor.

20. An automated climatization mechanism comprising the apparatus of claim 19, wherein the at least one sensor comprises a temperature sensor, a pressure sensor, a humidity sensor, and a time of flight sensor.

21. A hydraulic pump monitoring system comprising the apparatus of claim 19, wherein the at least one sensor comprises a vibration sensor, a current sensor, and a flow measurement sensor.

22. A non-transitory computer readable medium storing instructions that, when the instructions are executed by a computer, cause the computer to implement a method comprising:
performing an initialization that includes creating one or more categories and storing each category in a memory, wherein the number of created categories is strictly less than a predefined number of categories;
for at least one group of sets of learning data:
calculating a mean and a covariance matrix for the group of sets of learning data;
determining whether a first condition is verified, the first condition depending on an LU factorization of the covariance matrix and the first condition being verified according to whether the covariance matrix of the group of sets of learning data is poorly conditioned;
when the first condition is verified, adding a set of data to the group of sets of learning data and updating the mean and the covariance matrix of the group of sets of learning data;
creating a category associated with the mean and the covariance matrix of the group of sets of learning data and storing the category in the memory;
for each category stored in the memory, calculating a first measurement of distance between the category and each other category stored in the memory from the associated means and covariance matrices;
selecting two categories corresponding to a first minimum distance measurement; and
creating a single category by merging the two selected categories.

23. The computer readable medium according to claim 22, wherein the initialization comprises:
determining that a second condition is verified, the second condition being verified according to whether the number of categories stored in the memory is strictly less than the predefined number of categories;
for a group of sets of initialization data:
calculating a mean and a covariance matrix for the group of sets of initialization data;
when the first condition is verified, adding a set of data to the group of sets of initialization data and updating the mean and the covariance matrix of the group of sets of initialization data; and
creating a category associated with the mean and the covariance matrix of the group of sets of initialization data and storing the category in the memory.

24. The computer readable medium according to claim 22, wherein the method further comprises, for each received set of data:
storing the set of data in the memory;
for each category stored in the memory, calculating a second measurement of distance between the set of data and the category and selecting a second minimum distance measurement;
determining that a third condition is verified according to whether the second minimum distance measurement is greater than a distance threshold;
in response to the third condition being verified, detecting an anomaly; and
deleting the set of data from the memory.
